(19) United States
(12) Patent Application Publication
(10) Pub. No.: US 2014/0229332 A1
(43) Pub. Date: Aug. 14, 2014

(54) SYSTEMS AND METHODS FOR PROVIDING AN ONLINE TRADING SYSTEM

(71) Applicant: Dendrich Ltd., Delaware, OH (US)

(72) Inventors: Gong Wu, Delaware, OH (US); Tao Huang, Powell, OH (US); Yiguang Hu, Westerville, OH (US)

(73) Assignee: Dendrich Ltd., Delaware, OH (US)

(21) Appl. No.: 14/178,753

(22) Filed: Feb. 12, 2014

Related U.S. Application Data
(60) Provisional application No. 61/763,669, filed on Feb. 12, 2013.

(51) Int. Cl. G06Q 30/06

(52) U.S. Cl. CPC G06Q 30/0613
USPC 705/26.41

(57) ABSTRACT

Systems and methods for providing an online trading system may include a computing device comprising a processor, an information database, and a memory storing instructions that, when executed by the processor, cause the computing device to access product information on one or more products in the information database, to prompt a first user to input search information for at least one product via a user interface, to receive the search information provided by the first user input, and to search the product information based on the first user input. Systems and methods further display a search result formulated using the product information and corresponding to the first user input, and prompt the first user to input information on a specific product. The specific product is then settled to the first user either initially, or after inputs from a second user in response to the first user placing a purchase order.

### RELATED APPLICATIONS

This application claims the benefit of and priority to U.S. Provisional Application No. 61/763,669, entitled “Online Trading Systems and Methods,” which was filed on Feb. 12, 2013, the entire disclosure of which is incorporated herein by reference.

### FIELD OF THE INVENTION

The general inventive concepts relate to electronic commerce and, more particularly, to systems and methods for providing an online trading system for facilitating buy and sell transactions between buyers and sellers respectively.

### BACKGROUND

Traditional ecommerce systems such as Amazon® and eBay® provide a marketplace for buyers and sellers to interact and purchase goods and services from each other. However, such traditional systems do not provide a forum for buyers to list specific products or services that they wish to purchase, nor do such systems provide an opportunity for buyers to specify a particular price at which they wish to make the purchase. Similarly, sellers in traditional ecommerce systems lack the ability to ascertain the specific goods or services that buyers are interested in purchasing.

Further, traditional ecommerce systems do not allow sellers to adjust their product offerings (both the identity and price of the product) based on the buyers' providing specific product and price information on the products they wish to purchase. Additionally, such traditional systems do not allow sellers the opportunity to permanently create and provide detailed information regarding a product. Therefore, buyers lack the ability to browse the marketplace for specific product information following the removal of the original (non-permanent) listing.

Thus, there is an unmet need for online trading systems and methods that do not suffer from these drawbacks.

### BRIEF SUMMARY

The general inventive concepts contemplate systems, methods, and apparatuses for providing an online trading system for facilitating buy and sell transactions between buyers and sellers respectively. By way of example, to illustrate various aspects of the general inventive concepts, several exemplary embodiments of systems, methods, and/or apparatuses are disclosed herein.

Systems and methods, according to one exemplary embodiment, provide for an information database comprising product information on at least one product, a software program that accesses the information database in response to a first user's search for a specific product and displays the searched product to the first user. The first user may choose to purchase the selected product as-is, or to update the product information by providing specific inputs. A second user (seller) is given the ability to meet the updated specification provided by the first user, by providing a product that matches the first user's requirements. The first user is then able to purchase the specific product per his selected requirements.

Systems and methods, according to one exemplary embodiment, provide for a buyer to list a specific product that he wishes to purchase, along with detailed information regarding the product such as the price, quantity, and condition of the product. Systems and methods similarly provide for a seller to list a specific product that he wishes to sell, along with detailed information regarding the product.

Systems and methods, according to one exemplary embodiment, provide for buyers and sellers to interact on a real-time basis in furthering a sales transaction. Systems and methods also provide for a transparent marketplace, where the availability, demand, and price information on a product is open to inspection for any user of the marketplace, whether or not said user eventually consummates a sale. Further, buyers and sellers alike are provided the opportunity to review listings regardless of whether or not a particular product listed is available for sale at the time of review.

Additional features and advantages will be set forth in part in the description that follows, and in part will be obvious from the description, or may be learned by practice of the embodiments disclosed herein. The objects and advantages of the embodiments disclosed herein will be realized and attained by means of the elements and combinations particularly pointed out in the appended claims. It is to be understood that both the foregoing brief summary and the following detailed description are exemplary and explanatory only and are not restrictive of the embodiments disclosed herein or as claimed.

### BRIEF DESCRIPTION OF THE DRAWINGS

The accompanying drawings, which are incorporated in and constitute a part of this specification, illustrate some embodiments disclosed herein, and together with the description, serve to explain principles of the embodiments disclosed herein.

FIG. 1 is a schematic diagram of an exemplary environment for practicing the present invention in accordance with an aspect of the embodiments.

FIG. 2 illustrates an exemplary computing system that may be used to implement embodiments of the present technology in accordance with an aspect of the embodiments.

FIG. 3 shows the schematic diagram of FIG. 1, but including the Exchange Software of the present technology in accordance with an aspect of the embodiments.

FIG. 4 shows the interaction of the Exchange Software in relation to the users and products of the system in accordance with an aspect of the embodiments.

FIG. 5 is an exemplary flow chart of a method for generating a tradable order in accordance with an aspect of the embodiments.

FIG. 6 shows the interaction of the Exchange Software in relation to the users and products of the system, specifically showing the product detail information as stored in an information database in accordance with an aspect of the embodiments.

FIG. 7 shows an illustrative screenshot of a user registration page in accordance with an aspect of the embodiments.

FIG. 8 shows an illustrative screenshot of a product search page depicting the search for a product by a user in accordance with an aspect of the embodiments.

FIG. 9 shows an illustrative screenshot of a search results page depicting a plurality of search results for a searched product in accordance with an aspect of the embodiments.

FIG. 10 shows an illustrative screenshot of a product detail page of a selected product in accordance with an aspect of the embodiments.

FIG. 11 shows an illustrative screenshot of a product review page of a selected product in accordance with an aspect of the embodiments.

FIG. 12 shows an illustrative screenshot of a sales history page depicting the past sales of a specific user in accordance with an aspect of the embodiments.

FIG. 13 shows an illustrative screenshot of a pending trades page depicting pending trade orders awaiting user review in accordance with an aspect of the embodiments.

FIG. 14 shows an illustrative screenshot of a payments page depicting an order summary for a selected product in accordance with an aspect of the embodiments.

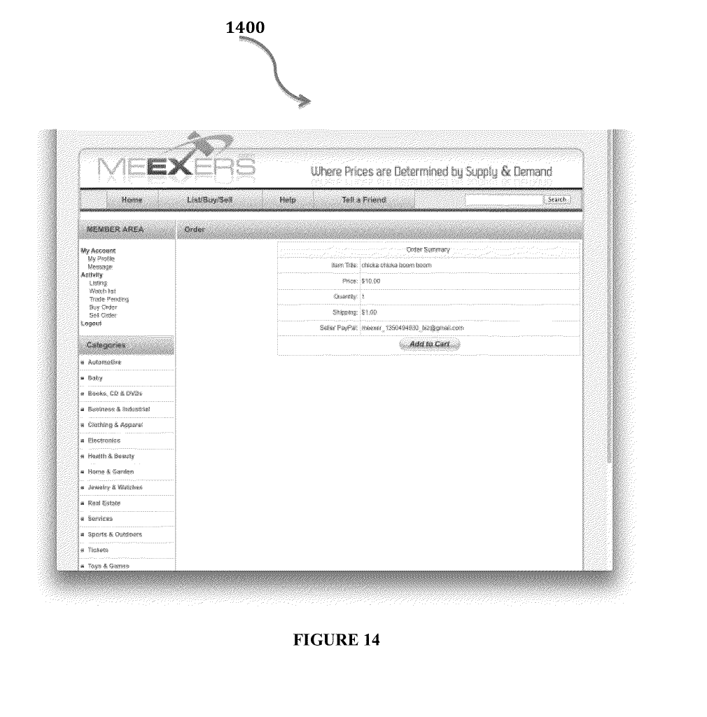

FIG. 15 shows an illustrative screenshot of a products page depicting a plurality of products that are part of a watch list of a specific user in accordance with an aspect of the embodiments.

FIG. 16 shows an illustrative screenshot of a search results page depicting a plurality of search results for a searched product in accordance with an aspect of the embodiments.

### DETAILED DESCRIPTION

The embodiments disclosed herein will now be described by reference to some more detailed embodiments, with occasional reference to the accompanying drawings. These embodiments may, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which these embodiments belong. The terminology used in the description herein is for describing particular embodiments only and is not intended to be limiting of the embodiments. As used in the specification and the appended claims, the singular forms “a,” “an,” and “the” are intended to include the plural forms as well, unless the context clearly indicates otherwise. The patent application mentioned herein is incorporated by reference in its entirety.

The following are definitions of exemplary terms used throughout the disclosure. Both singular and plural forms of all terms fall within each meaning:

“Computer” or “computing device” as used herein includes, but is not limited to, any programmed or programmable electronic device, microprocessor, or logic circuit that can store, retrieve, and process data.

“Portable computing devices” include, but are not limited to, computing devices that combine the powers of a conventional computer in portable environments. Exemplary portable computing devices include portable computers, tablet computers, internet tablets, Personal Digital Assistants (PDAs), ultra mobile PCs (UMPCs), carputers (typically installed in automobiles), wearable computers, and smartphones. The term “portable computing device” can be used synonymously with the terms “computer” or “computing device.”

“Web browser” as used herein, includes, but is not limited to, software for retrieving and presenting information resources on the World Wide Web. An information resource may be a web page, an image, a video, a sound, or any other type of electronic content.

“Software” or “computer program” as used herein includes, but is not limited to, one or more computer or machine readable and/or executable instructions that cause a computer, a portable computing device, microprocessor, logic circuit, or other electronic device to perform functions, actions, and/or behave in a desired manner. The instructions may be embodied in various forms such as routines, algorithms, modules or programs, including separate applications or code from dynamically linked libraries. Software may also be implemented in various forms such as a stand-alone program, an app, a function call, a servlet, an applet, instructions stored in a memory or any other computer readable medium, part of an operating system or other type of executable instructions. It will be appreciated by one of ordinary skill in the art that the form of software is dependent on, for example, requirements of a desired application, the environment it runs on, and/or the desires of a designer/programmer or the like.

“Mobile application” as used herein, includes, but is not limited to, applications that run on smart phones, tablet computers, and other mobile or portable computing devices. The terms “mobile application” or “mobile app” or “software application” or “application” or “app” can be used synonymously with “software” or “computer program” or “application software.” Mobile applications allow users to connect to services that are traditionally available on the desktop or notebook platforms. Typically, these services access the Internet or intranet or cellular or wireless fidelity (Wi-Fi) networks, to access, retrieve, transmit and share data.

“Memory” as used herein is memory that is visible to and/or directly addressable by software executed on a processor.

“Processor” as used herein, refers to central processing units, microprocessors, microcontrollers, reduced instruction set circuits (RISC), application specific integrated circuits (ASIC), logic circuits, and any other circuit or processor capable of executing the functions described herein.

“Network” as used herein, includes, but is not limited to, a collection of hardware components and computers or machines interconnected by communication channels that allow sharing of resources and information, including without limitation, the worldwide web or Internet.

“Server” as used herein, includes, but is not limited to, a computer or a machine or a device on a network that manages network resources. The general term “server” may include specific types of servers, such as a File Server (a computer and storage device dedicated to storing files), Print Server (a computer that manages one or more printers), a Network Server (a computer that manages network traffic), and a Database Server (a computer system that processes database queries). Although servers are frequently dedicated to performing only server tasks, certain multiprocessing operating systems allow a server to manage other non-server related resources.

“Web server” as used herein, includes, but is not limited to, a server which serves content to a web browser by loading a file from a disk and serving it across a network to a user's web browser, typically using a hyper text transfer protocol (HTTP). Alternately, “Web server” as used herein, includes, but is not limited to, a server which serves content to a web browser by automatically generating a response. The response is generated by combining a search result from a database or other repository with calculations based on client request parameters and business rules and logic embedded in the software.

“Instructions” as used herein is synonymous to “Source code” or “product code”, and includes, but not limited to, a textual software code, or a machine code, or notations in graphical software languages, which specify actions to be performed by a machine, which includes, but not limited to, a computer.

Although the embodiments disclosed herein have been primarily directed to a personal computer (PC) or other relatively fixed console computers implementing a “desktop” version of the inventive software, the general inventive concepts could be readily extended to, and may be pursued with reference to a portable computing device using mobile application software.

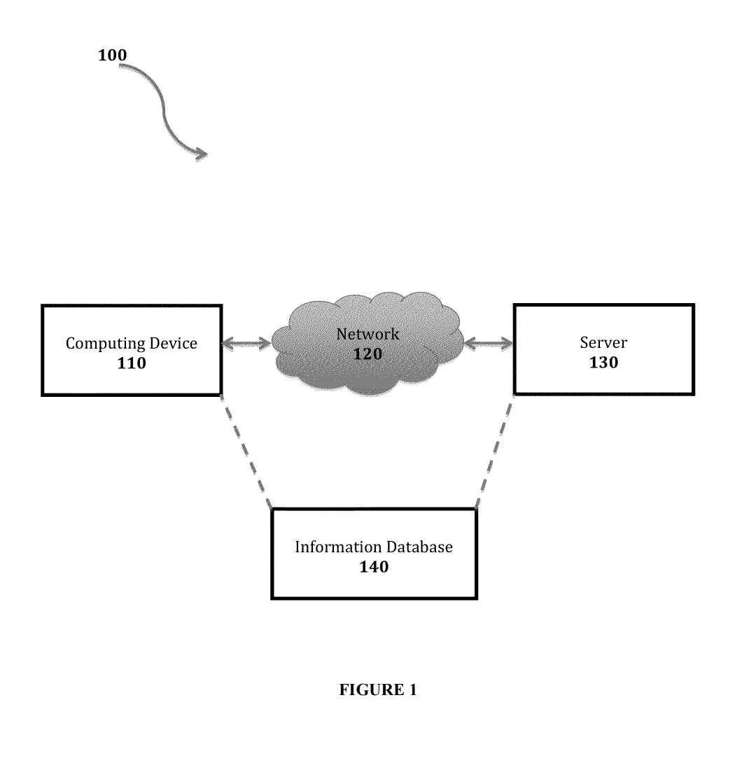

FIG. 1 illustrates an exemplary environment 100 for practicing the present invention. In general, the environment 100 may include a computing device 110 having one or more computer programs residing thereon. In additional exemplary embodiments, the exemplary environment 100 may include both the computing device 110 and a server 130 cooperating together to execute separate components of a computer program. The computing device 110 and the server 130 may be operatively connected to one another via a network 120. The exemplary environment may further include an information database 140 operatively connected to the computing device 110, or server 130, or both. A server as used herein may also include a web server capable of serving content to a web browser.

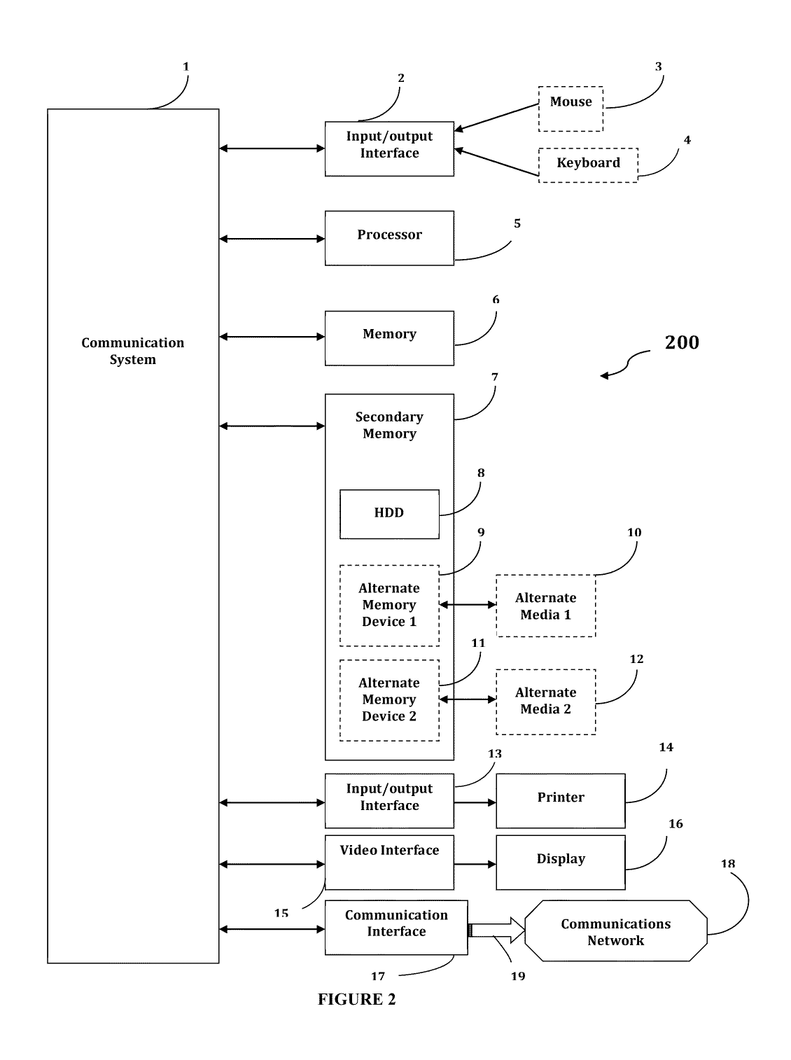

FIG. 2 illustrates an exemplary computing system 200 that may be used to implement embodiments of the present technology, wherein the processes of present invention may be implemented as software, such as a computer program executing within the computing system 200. System 200 may be implemented in the contexts of the computing device 110 or the server 130, or a combination of both 110 and 130, as described with reference to FIG. 1.

The steps of the inventive methods are guided by instructions in the software that are carried out by the computing device. Software may be stored in a computer readable medium, including, for example, the storage devices described below. Software is loaded into the computer from the computer readable medium, and then executed by the computing device.

The computing system 200 comprises communication system 1, input devices such as a mouse 3, a keyboard 4, and output devices such as a printer 14 and a display device 16. The components of the computing system 200, typically communicate via a communication system 1. Communication system 1 may be an interconnected bus, the conventional operation of which is known to those in the relevant art. A communication interface 17 is used by the computing device 200 for communicating to and from a communications network 18 (e.g. Local Area Network (LAN) or a Wide Area Network (WAN)) via an interface connector 19.

The computing system 200 typically includes a processor 5, a memory unit 6, interfaces including a video interface 15, and input/output (I/O) interfaces 2 and 13. System 200 also includes a secondary memory/storage device 7 that typically includes a hard disk drive (HDD) 8 and alternate memory devices 9 and 11. Alternate memory devices 9 and 11 may comprise magnetic disc drives, CD ROM drives, Flash drives, USB drives, SD Card drives and the like. Alternate memory devices 9 and 11 in turn connect to alternate media 10 and 12, such as a CD ROM, Flash drive etc.

In an embodiment, the software of the preferred embodiment is resident on the hard disk drive 8 and read and controlled by the execution of the processor 5. Intermediate storage of the program and any data fetched (e.g. from the network 120) may be accomplished using the memory 106, possibly in concert with the hard disk drive 8. Additionally, the software of the preferred embodiment may also be loaded on to the system 200 via alternate memory devices 9 and 11.

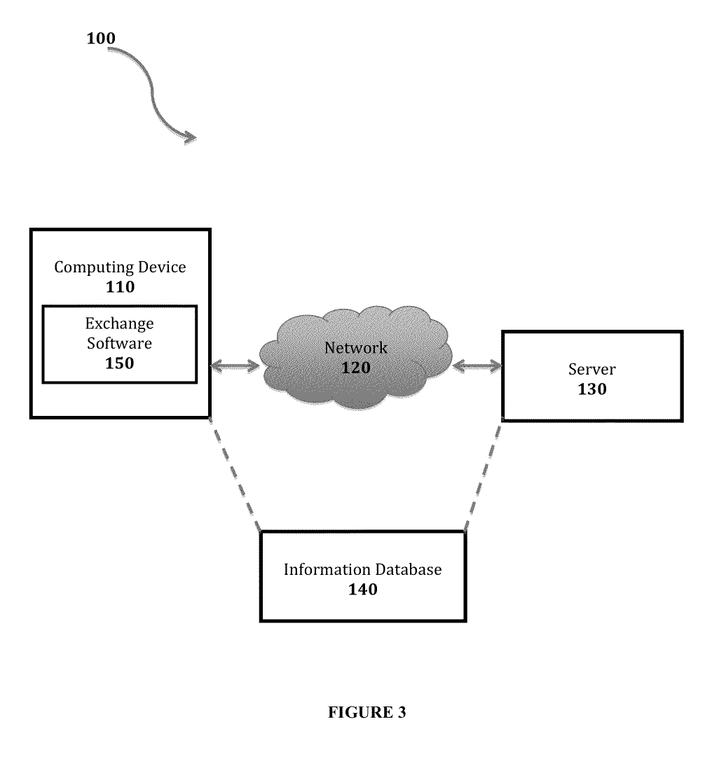

FIG. 3 illustrates the exemplary environment 100, including the exemplary computing device 110 with inventive software 150. As described earlier with reference to FIG. 2, software 150 is resident on the hard disk drive of the computing device 110 and is read and controlled by the execution of the processor of the computing device.

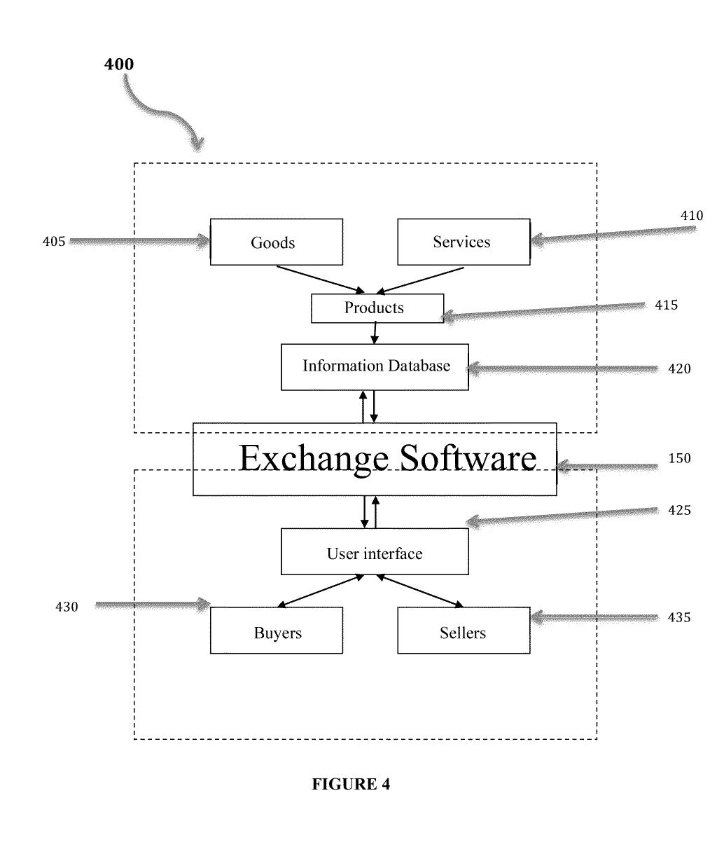

FIG. 4 illustrates an environment 400, which includes the exchange software 150 in conjunction with the users and products interacting with it. Specifically, buyers 430 and sellers 435 utilize user interface 425 to interact with the exchange software 150. Products 415, which include one or more goods 405 and/or one or more services 410, are constantly updated in the information database 420, which then interfaces with the exchange software 150 in order to provide real time information to the buyers 430 and sellers 435. Information database 420 comprises product information on all products 415.

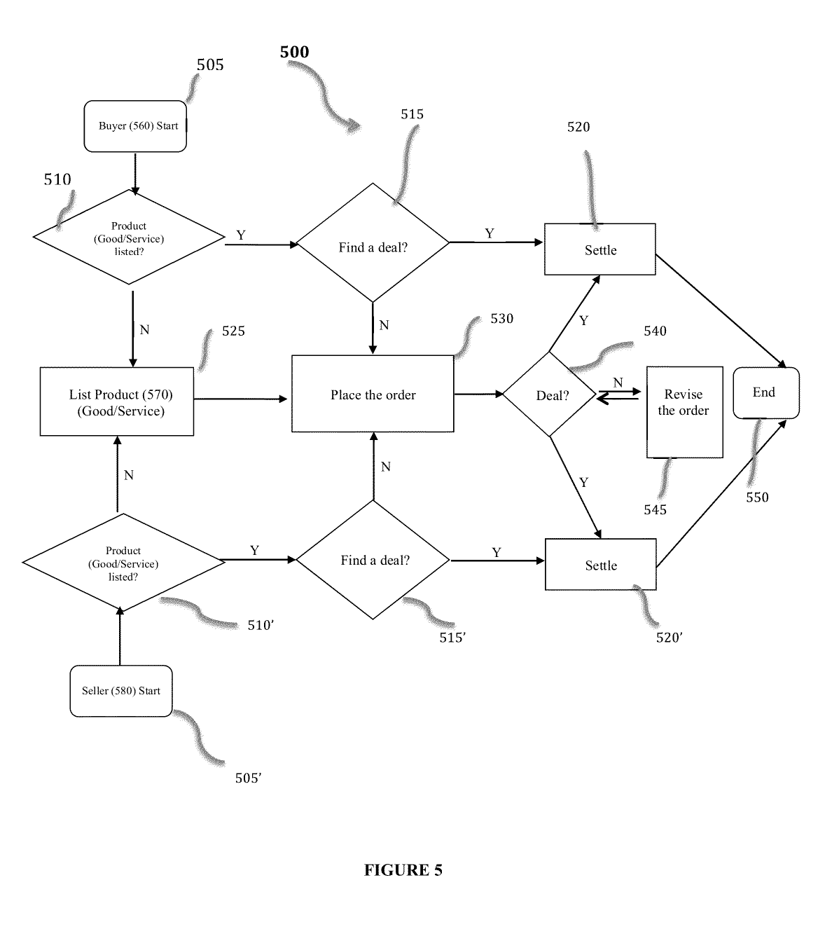

Referring now to FIG. 5, a method of generating a tradable order is described via a flowchart 500. At step 505, a buyer 560 starts buy-side tradable order process. At step 510, buyer 560 searches for a specific product 570. If the product 570 is listed, buyer proceeds to step 515, where he determines whether the listed product 570 meets his buy-side requirements. Buy-side requirements may be any parameters of interest for the buyer. For example, buyer 560 may have buy-side parameters that require a product 570 at a particular price. If buyer 560 is satisfied with the listed product 570 (as having met his buy-side requirements), buyer 560 may then choose to “settle” the transaction with the listed product 570.

“Settle,” or “settling” as used herein refers to the process by which a buyer agrees to trade a product with a seller at an agreed upon price. For instance, if a seller lists Product A for $50, and a buyer searches for and finds Product A, and further agrees with the pricing of Product A, the buyer may then choose to purchase (“trade”) Product A from the seller at the listed price. As a natural extension to agreeing to purchase a product, settling may also include the process by which the buyer pays for the product and the process by which the seller receives the funds for the sold product. Settling a product removes the purchased quantity of the product from both the buyer's and seller's inventory. For example, if the seller has 10 quantities of Product A to sell, and the buyer wishes to purchase 5 quantities of Product A from the seller, after the transaction is settled between the buyer and the seller, the seller is left with only 5 additional quantities of Product A to sell. Similarly, if the buyer initially sets out to purchase 8 quantities of Product A, but decides to buy only 5 quantities of Product A from the seller, the buyer's inventory of Product A reduces to 3.

Referring further to FIG. 5, if at step 515, product 570 does not meet buyer's 560 buy-side parameters; buyer 560 may choose to place an order for product 570 at step 530. At this step, buyer 560 may list in detail the specific buy-side parameters for product 570 that he wishes to purchase. In the exemplary embodiments, a buyer's 560 listing of his preferred product would be identical to a seller's listing of their product on sale, excepting that the buyer's 560 listing would have an option for a seller to accept the buy-side parameters (“buyer bid”), while the seller's listing would have an option for a buyer to accept the sale-side parameters (“seller bid”).

At step 505′, a seller 580 starts the sell-side tradable order process. At step 510′, seller 580 searches for the specific product 570. If the product 570 is listed, seller 580 proceeds to step 515′, where he determines whether there are any buyers 570 looking for the listed product 570 in conforming to his sell-side requirements. Sell-side requirements may be any parameters of interest for the seller. For example, seller 580 may have buy-side parameters that require a product 570 at a particular price. If seller 580 is satisfied with the buyer's 560 offer for the listed product 570 (as having met his sell-side requirements), seller 580 may then choose to “settle” the transaction with the listed product 570.

If at step 515′, a buyer's 560 offer for product 570 does not meet seller's 580 sell-side parameters; seller 580 may choose to place an order for product 570 at step 530. At this step, seller 580 may list in detail the specific sell-side parameters for product 570 that he wishes to sell. Effectively, the seller's 580 listing would have an option for a buyer 560 to accept the sale-side parameters (“seller bid”).

If the buy-side requirements of buyer 560 and sell-side requirements of seller 580 match, the buyer 560 and seller 580 may choose to close the deal at step 540. If a deal is not reached, buyer 560 and seller 580 may have an opportunity to re-work their buy-side and sell-side parameters respectively, until a deal is reached. Once a deal is reached, the buyer and seller settle at 520 (or 520′). The process ends at 550 with the product 570 being settled.

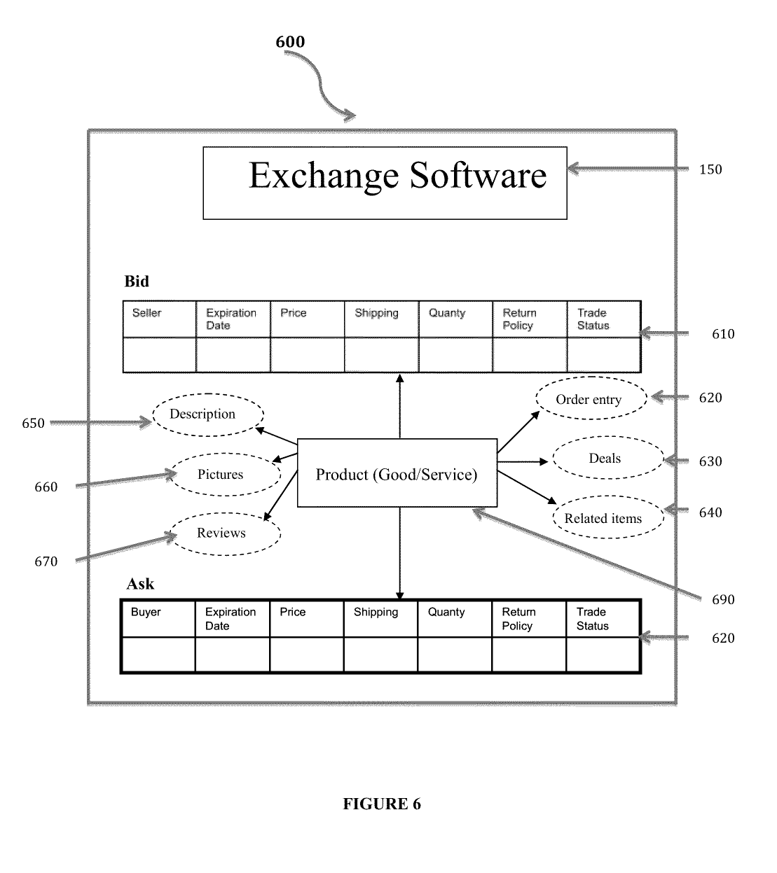

FIG. 6 shows the exchange software 150 interactions with buyers and sellers. A buyer “asks” for a product 570 by listing their “ask” as a product listing. Product listing 620 outlines the buy-side parameters of the buyer 560. The buy-side parameters and sell-side parameters may be referred to as “product information.” When the buyer “asks” for a product 570, the product information is searched from the information database 140. If product 570 is available in the database 140, buyer 560 will see a product listing along with the product information, as shown in listing 620. The product information is gathered by the information database 140 and passed through the exchange software 150. Exemplary product information is shown in FIG. 6 as product description 650, product pictures 660, product reviews 670, related deals 630, related items 640, and order entry 620. The exemplary product information shown in FIG. 6 is for illustrative purposes only. There may be other parameters to the product information not shown here. Additional product information is shown in listings 610 and 620. For example, listings 610 and 620 show the identities of the seller and buyer respectively, in addition to the expiration date of the product 570 listing, product price, shipping information, quantity of product 570 available, product 570 return policy, and a trade status for product 570. Trade status as used herein describes the present state of a given trade. For instance, if a buyer 560 “asks” for a product 570 from the seller 580, the trade status of the product 570 on the seller's side would show a “Trade Now” message, for example, to indicate the next steps for the seller. Similar trade status indicators would also appear on the buyer's 560 side when a buyer's buy-side parameters are being met by a seller's 580 listing.

Referring further to FIG. 6, if a buyer's 560 ask is not in the information database 140, buyer 560 is able to create the product listing 620 by inputting the product information of his choice. Such listing 620 would then be stored in the database 140 for later access. Similarly, a seller 580 may list a product 570 via listing 610 incorporating the product information of his choosing. The listing 610 may be a “new” listing not particularly in response to a buyer's 560 listing, or may be a “responsive” listing in response to a buyer's 580 ask of a product 570. Similar to listing 620, listing 610 is also stored in the database 140 for later access.

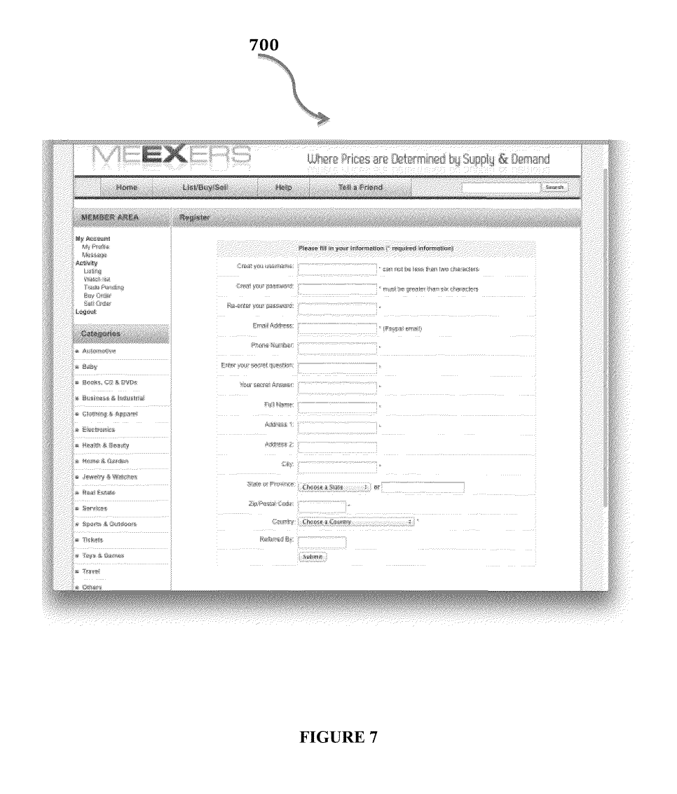

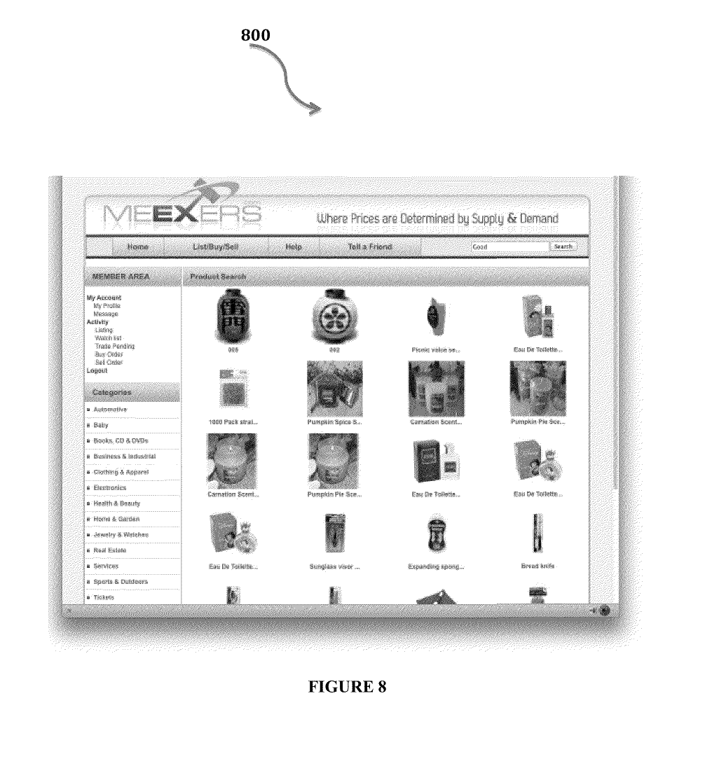

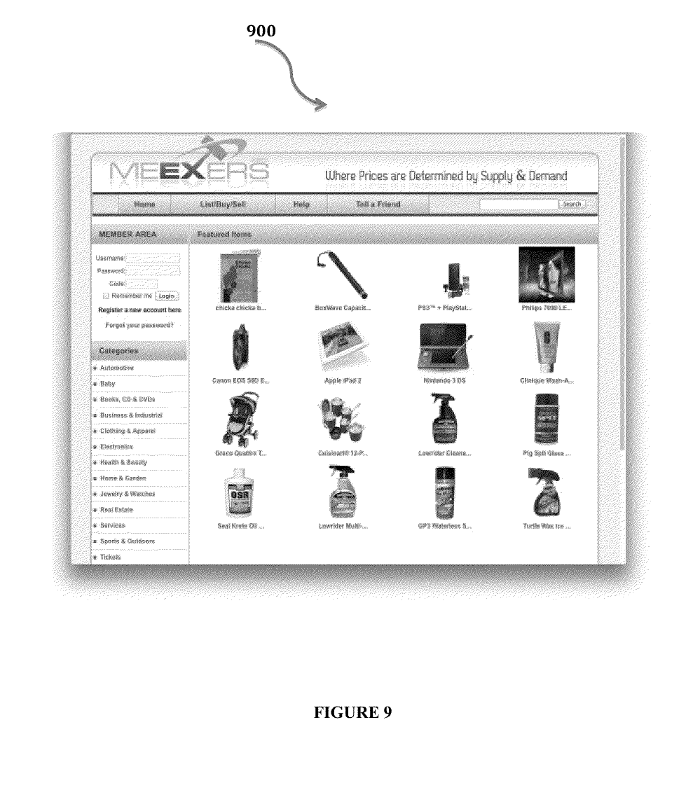

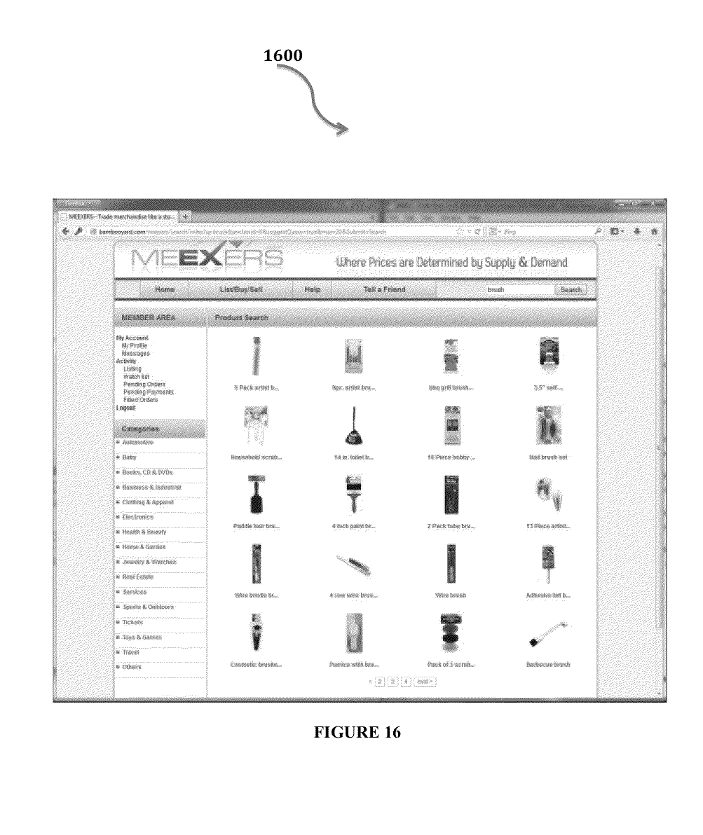

FIG. 7 is an exemplary screenshot 700 of an embodiment of the present invention showing a user 710 (not shown) registration. A user 710 may be a buyer 560 or a seller 580. FIG. 8 is an exemplary screenshot 800 of an embodiment of the present invention, showing the user 710 searching for a product 570 in the software 150, via database 140. FIG. 9 is an exemplary screenshot 900 of the search results of the user's 710 search for product 570. Screenshot 900 shows one or more products that match user's 710 search for product 570. For example, if the user 710 searched for a “shoe,” all product listings that contain the term “shoe” in their respective product information would be retrieved from the database 140 and displayed to the user 710 on screen 900. Similarly, FIG. 16 is an exemplary screenshot 1600 of the search results of the user's 710 search for product 570. Screenshot 1600 shows one or more products that match user's 710 search for product 570. For example, if the user 710 searched for a “shoe,” all product listings that contain the term “shoe” in their respective product information would be retrieved from the database 140 and displayed to the user 710 on screen 1600. Alternately, screenshot 900 may display a “Featured Items” list of products. Featured items may be those products 570 that are tagged by either the seller 580, or the buyer 560 or an administrator of the system 200 with a “featured” or special status. For example products 570 that are on sale, are popular in the marketplace, have a price or other discount, or have a certain number of views may all be tagged as featured products.

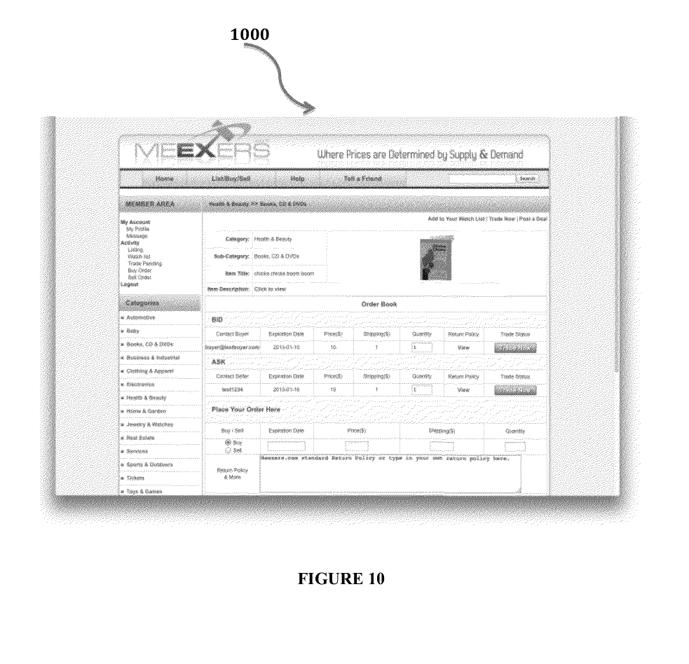

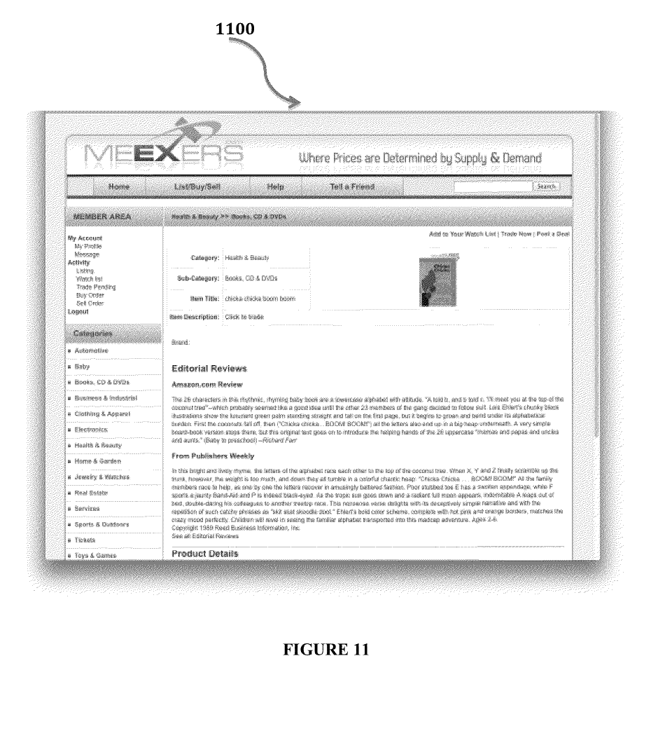

If user 710 selects a particular product on screen 900 or screen 1600, an exemplary view of the selected product is shown in FIG. 10 in screenshot 1000. As shown in screenshot 1000, the selected product's product information is displayed to user 710 in a user-friendly format, including a listing of the product, and the opportunity for the user 710 to place an order for the selected product. Exemplary screenshot 1100 of FIG. 11 provides further information on the selected product, specifically product reviews associated with the product.

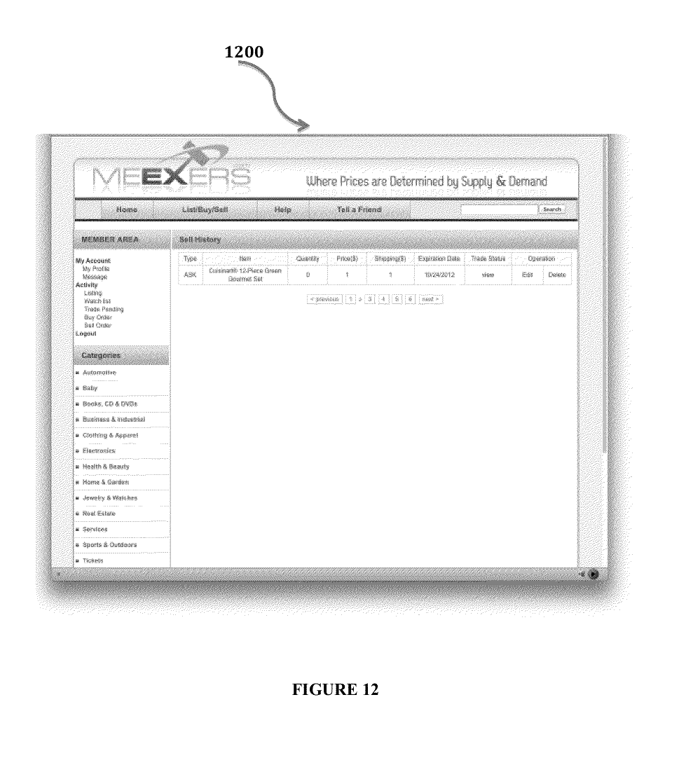

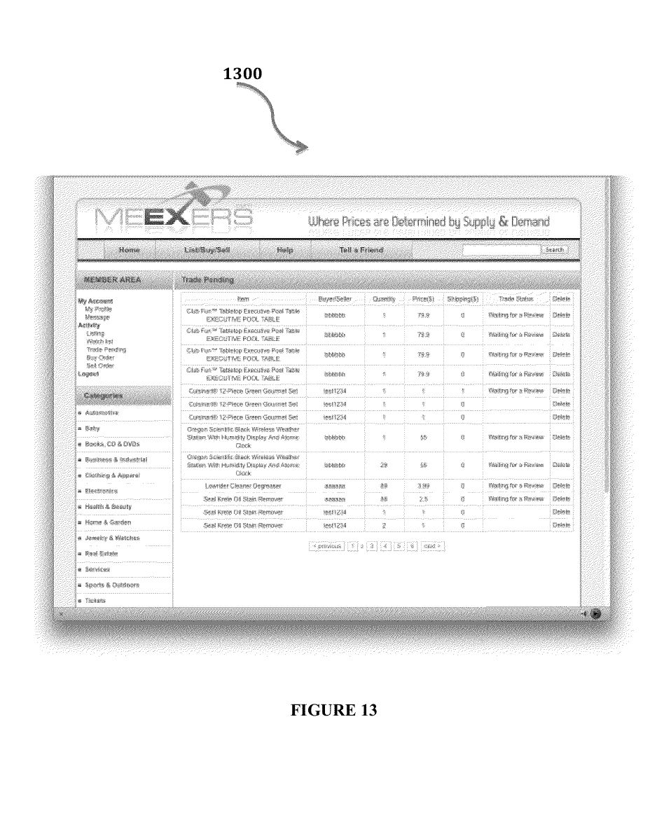

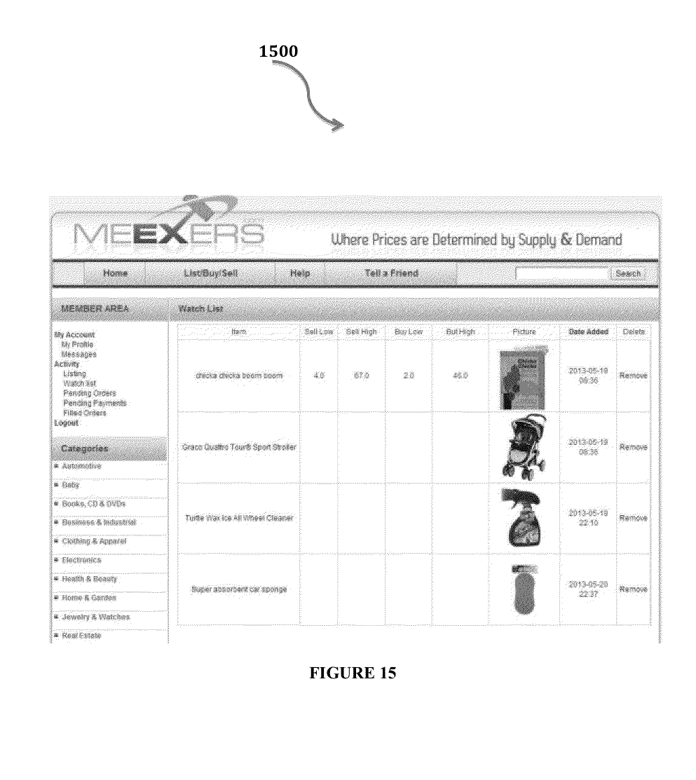

Exemplary screenshot 1200 of FIG. 12 shows a seller's 580 sales history. Exemplary screenshot 1300 of FIG. 13 shows a user's 710 pending trades. As described above with reference to FIG. 6, a user's 710 trade status under the pending trades screen shows all trades (buy/sell orders) for which the user's 710 input is awaited. For example, if buyer 560 places an order for product 570 that the seller 580 has listed for sale, screen 1300 would show that the particular order for product 570 is awaiting review by the seller 580. Exemplary screenshot 1400 shows an order summary/payment page, utilizing which a user 710 may complete the product 570 purchase and “settle” the transaction. Exemplary screenshot 1500 of FIG. 15 shows an screenshot of a products page depicting a plurality of products 570 that are part of a watch list of the user 710. A product 570 depicted on the watch list is a good or service that the buyer 560 or seller 580 or user 710 doesn't intend to buy or sell immediately, but wishes to save for later viewing.

The above description of specific embodiments has been given by way of example. From the disclosure given, those skilled in the art will not only understand the general inventive concepts and attendant advantages, but will also find apparent various changes and modifications to the structures and methods disclosed. For example, the general inventive concepts are not typically limited to any particular interface between a user and the user's computing device. Thus, for example, use of alternative user input mechanisms, such as voice commands and keyboard entries, are within the spirit and scope of the general inventive concepts. As a further example, the general inventive concepts are not typically limited to implementing the Exchange Software using a particular programming language. One or more open-source or proprietary programming languages may therefore, implement the Exchange Software. It is sought, therefore, to cover all such changes and modifications as fall within the spirit and scope of the general inventive concepts, as described and claimed herein, and equivalents thereof.

1. An exchange system comprising:
a computing device comprising a processor, an input means, and an output means; an information database comprising product information on at least one product; and a memory storing instructions that, when executed by the processor, cause the computing device to:
via the server, access the product information in the information database;
prompt a first user to input search information for at least one product via a user interface;
receive the search information provided by the input means as first user input;
search the product information based on the first user input;
display a search result formulated using the product information and corresponding to the first user input on the input means;
prompt the first user to input information on a specific product using the search result;
settle the specific product to the first user in response to receiving a settling order from the user;
prompt the first user to place a purchase order for the specific product in lieu of receiving a settling order for the specific product from the first user;
receive updated product information for the specific product from a second user in response to the first user placing the purchase order; and
settle the specific product to the first user in response to receiving the updated product information from the second user.

2. A non-transitory computer readable storage medium having stored thereon, executable instructions for generating a tradable order, wherein the executable instructions are configured to be executed on a computing device to carry out a method comprising:
searching an information database in response to a first input;
determining an availability of a product based on the first input, wherein the result of the determining step is the display of an available first product, wherein the display of the first product comprises a first product information;
settling an order for the first product if no changes are made to the first product information via a second input;
placing a purchase order for the first product if changes are made to the first product information in response to the second input;
updating the first product information via a third input in response to the purchase order; and
settling an order for the first product in response to third input.

3. The method of claim 2 wherein the specific product is one of a good and a service.

4. (canceled)

5. The method of claim 2 wherein the first product information comprises a photograph of the product.

6. The method of claim 2 wherein the first product information comprises at least one of a product title, a description of the product, a product price, and a product quantity.

7. (canceled)

8. (Canceled)

9. (canceled)

10. The method of claim 2 wherein the first product information comprises a shipping charge for shipping the product.

11. The method of claim 2 wherein the first product information comprises an expiration date,
wherein the product becomes unavailable for purchase as of the expiration date.

12. The method of claim 2 wherein the first product information comprises a return policy of the product.

13. The method of claim 2 wherein the first product information comprises a trade status of the product.

14. The method of claim 2 wherein the first product information comprises a review of the product.

15. A non-transitory computer readable storage medium having stored thereon, executable instructions for generating a tradable order, wherein the executable instructions are configured to be executed on a computing device to carry out a method comprising:
searching an information database in response to a first input;
determining an availability of a product based on the first input, wherein the result of the determining step is the display of an unavailable first product;
listing a first product information for the unavailable first product in response to a second input;
updating the first product information via a third input in response to the listing of the first product information, wherein the updating step generates a revised first product information;
settling an order for the first product if no changes are made to the revised first product information via a fourth input;
placing a purchase order for the first product if changes are made to the revised first product information in response to the fourth input;
updating the revised first product information via a fifth input in response to the purchase order; and
settling an order for the first product in response to fifth input.

16. The method of claim 15 wherein the specific product is one of a good and a service.

17. (canceled)

18. The method of claim 15 wherein the first product information comprises a photograph of the product.

19. The method of claim 15 wherein the first product information comprises at least one of a product title, a description of the product, a product price, and a product quantity.

20. (canceled)

21. (Canceled)

22. (canceled)

23. The method of claim 15 wherein the first product information comprises a shipping charge for shipping the product.

24. The method of claim 15 wherein the first product information comprises an expiration date,
wherein the product becomes unavailable for purchase as of the expiration date.

25. The method of claim 15 wherein the first product information comprises a return policy of the product.

26. The method of claim 15 wherein the first product information comprises a trade status of the product.

27. The method of claim 15 wherein the first product information comprises a review of the product.
